(19) United States
(12) Patent Application Publication
(10) Pub. No.: US 2022/0014122 A1
(43) Pub. Date: Jan. 13, 2022

(54) SINGLE PHASE MOTOR DRIVING CIRCUIT, AND DRIVING METHOD THEREOF

(71) Applicant: Johnson Electric International AG, Murten (CH)

(72) Inventors: Yue LI, Hong Kong (CN); Xiuwen YANG, Shen Zhen (CN); Enhui WANG, Shen Zhen (CN); Shujuan HUANG, Shen Zhen (CN); Guodong LIU, Shen Zhen (CN); Haibo JIANG, Shen Zhen (CN); Yunlong JIANG, Shen Zhen (CN)

(21) Appl. No.: 17/368,605

(22) Filed: Jul. 6, 2021

(30) Foreign Application Priority Data
Jul. 7, 2020 (CN) 202010647341.3

(51) Int. Cl. H02P 1/46; H02P 6/18; H02P 27/024; H02P 6/26

(52) U.S. Cl. CPC H02P 1/465; H02P 6/26; H02P 27/024; H02P 6/18

(57) ABSTRACT

The present disclosure provides a single phase motor driving circuit which includes a stator winding, a control unit, a controllable bidirectional AC switch, and two power input terminals configured to connect an AC power source. The stator winding includes a first winding and a second winding. The parallel-connected first winding and second winding and the controllable bidirectional AC switch are connected in series between the two power input terminals. The control unit is connected to a control electrode of the controllable bidirectional AC switch, to control the controllable bidirectional AC switch to be switched on and off. The present disclosure further provides a driving method for the single phase motor driving circuit. The single phase motor driving circuit and the driving method thereof has better reliability while ensuring sufficient starting torque.

### CROSS REFERENCE TO RELATED APPLICATIONS

This non-provisional patent application claims priority under 35 U. S. C. § 119(a) from Patent Application No. 202010647341.3 filed in The People's Republic of China on Jul. 7, 2020, the entire contents of which are hereby incorporated by reference.

### FIELD OF THE INVENTION

This present disclosure relates to a motor driving technique, and more particularly to a single phase motor driving circuit, and a driving method thereof.

### BACKGROUND OF THE INVENTION

Existing single phase motors include a stator and a permanent magnet rotor which is rotatable relative to the stator. A driving circuit of the motors usually includes a single stator winding, a controllable bidirectional alternating current (AC) switch, a position sensor and a switch control module. The stator winding is connected to two terminals of an external AC power source via the controllable bidirectional AC switch. The switch control module controls the controllable bidirectional AC switch to be switched between a switch-on state and a switch-off state in a predetermined way, based on a magnetic pole position information of the rotor detected by the position sensor and a voltage polarity of the external AC power source, so that the stator winding drives the rotor along a starting direction during motor starting phase.

However, the existing single phase motors have the following problems. In order to ensure sufficient starting torque, a current flowing through the stator winding usually is high. Adverse effects generated by the high current will affect the reliability of components such as the position sensor and the switch control module in the single-phase motor drive circuit.

### SUMMARY

Thus, there a desire for a single phase motor driving circuit and a driving method thereof, which have good reliability and sufficient starting torque.

According to one aspect, a single phase motor driving circuit for driving a permanent magnet rotor of the motor to rotate relative to a stator is provided. The single phase motor driving circuit includes a stator winding, a control unit, a controllable bidirectional AC switch, and two power input terminals configured to connect an AC power source, wherein the stator winding comprises a first winding and a second winding; the parallel-connected first winding and second winding, and the controllable bidirectional AC switch are connected in series between the two power input terminals; and the control unit is connected to a control electrode of the controllable bidirectional AC switch, to control the controllable bidirectional AC switch to be switched on and off.

Preferably, a current buffer is connected between the control unit and the control electrode of the controllable bidirectional AC switch.

Preferably, the stator winding further comprises at least one winding connected in parallel with the first winding or the second winding.

Preferably, the control unit comprises a position sensor and a switch control module, the position sensor is configured to detect a magnetic field of the permanent magnet rotor, and output a corresponding signal representing the magnetic field; and the switch control module is configured to switch on the controllable bidirectional AC switch, when the AC power source is a positive half cycle and the magnetic field detected by the position sensor is the first polarity, and when the AC power source is a negative half cycle and the magnetic field detected by the position sensor is the second polarity opposite to the first polarity.

According to another aspect, a single phase motor driving circuit for driving a permanent magnet rotor of the motor to rotate relative to a stator is provided. The single phase motor driving circuit comprises a stator winding, a control unit, a first controllable bidirectional AC switch, a second controllable bidirectional AC switch, and two power input terminals configured to connect an AC power source, wherein the stator winding comprises a first winding and a second winding; the first winding and the first controllable bidirectional AC switch are connected in series between the two power input terminals; the second winding and the second controllable bidirectional AC switch are connected in series between the two power input terminals; and the control unit is connected to control electrodes of the first controllable bidirectional AC switch and the second controllable bidirectional AC switch, to control the two controllable bidirectional AC switches to be switched on and off at the same time.

Preferably, the stator winding further comprises at least one winding which is connected in parallel with the second winding.

Preferably, the single phase motor driving circuit further comprises at least one branch connected between the two power input terminals, wherein the branch comprises a winding and a controllable bidirectional AC switch which are connected in series.

Preferably, a current buffer is connected between the control unit and the control electrode of the first controllable bidirectional AC switch, and is also connected between the control unit and the control electrode of the second controllable bidirectional AC switch.

Preferably, the control unit comprises a position sensor and a switch control module, the position sensor is configured to detect a magnetic field of the permanent magnet rotor, and output a corresponding signal representing the magnetic field; and the switch control module is configured to switch on the two controllable bidirectional AC switches, when the AC power source is a positive half cycle and the magnetic field detected by the position sensor is the first polarity, and when the AC power source is a negative half cycle and the magnetic field detected by the position sensor is the second polarity opposite to the first polarity.

According to still another aspect, a single phase motor driving circuit for driving a permanent magnet rotor of the motor to rotate relative to a stator is provided. The single phase motor driving circuit comprising a stator winding, a control unit, a first controllable bidirectional AC switch, a second controllable bidirectional AC switch, and two power input terminals configured to connect an AC power source, wherein the stator winding comprises a first winding and a second winding; the first winding and the first controllable bidirectional AC switch are connected in series between the two power input terminals; the second winding and the second controllable bidirectional AC switch are connected in series between the two power input terminals; the control unit is connected to a control electrode of the first controllable bidirectional AC switch via a switching element, the control unit is connected to a control electrode of the second controllable bidirectional AC switch; and the switching element is turned on when the motor is started, and the switching element is turned off after the motor is successfully started.

Preferably, a surge voltage suppression unit is connected between two main electrodes of the first controllable bidirectional AC switch.

Preferably, the switching element comprises a switch connected between the control electrode of the first controllable bidirectional AC switch and the control unit, and a timer for controlling the switch to be turned on or off.

Preferably, the switching element comprise a first switching transistor, a second switching transistor, a first resistor, a second resistor, a first capacitor, a second capacitor, a first diode and a second diode; a control terminal of the first switch transistor is connected to a control electrode of the first controllable bidirectional AC switch via the first resistor, the first capacitor, a cathode and an anode of the first diode in turn, a first terminal of the first switching transistor is connected to the control unit, and a second terminal of the first switching transistor is connected to the cathode of the first diode; and a control terminal of the second switch transistor is connected to the control unit via the second resistor, the second capacitor, a cathode and an anode of the second diode in turn, a first terminal of the second switching transistor is connected to the control electrode of the first controllable bidirectional AC switch, and a second terminal of the second switching transistor is connected to the cathode of the second diode.

Preferably, the control unit comprises a position sensor and a switch control module, the position sensor is configured to detect a magnetic field of the permanent magnet rotor, and output a corresponding signal representing the magnetic field; and the switch control module is configured to switch on the corresponding controllable bidirectional AC switch only when the AC power source is a positive half cycle and the magnetic field detected by the position sensor is the first polarity, and the AC power source is a negative half cycle and the magnetic field detected by the position sensor is the second polarity opposite to the first polarity.

According to still another aspect, a driving method of the above-described single phase motor driving circuit is provided, which includes the following steps:

when the motor is started, the switching element is turned on, and the control unit controls the first and second controllable bidirectional AC switches to be switched on, so that the AC power source and the parallel-connected first and second windings form a loop circuit; and

when the motor is successfully started, the switching element is turned off, so that the first controllable bidirectional AC switch is switched off, and the AC power source and the second winding form a loop circuit.

Compared to existing motors, the single phase motor driving circuit of the present disclosure can improve adverse effects caused by high current while ensuring sufficient starting torque, so that the single phase motor driving circuit has a good reliability.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a diagrammatic representation of a single phase motor according to an exemplary embodiment of the present disclosure;

FIG. 2 is a block diagram of a single phase motor driving circuit according to a first embodiment of the present disclosure;

FIG. 3 is a block diagram of a single phase motor driving circuit according to a second embodiment of the present disclosure;

FIG. 4 is a block diagram of a single phase motor driving circuit according to a third embodiment of the present disclosure;

FIG. 5 is a block diagram of a single phase motor driving circuit according to a fourth embodiment of the present disclosure;

FIG. 6 is a block diagram of a control unit of the single phase driving circuits illustrated in FIGS. 2 to 5.

FIG. 7 is a circuit diagram of the control unit of FIG. 6 according to a preferable embodiment of the present disclosure;

FIG. 8 is a circuit diagram of a switching element of the single phase motor driving circuit illustrated in FIG. 5 according to a preferable embodiment of the present disclosure.

### DETAILED DESCRIPTION OF THE PREFERRED EMBODIMENTS

The subject matter will be described in conjunction with the accompanying drawings and the preferred embodiments. The described embodiments are only a few and not all of the embodiments of the present disclosure. All other embodiments obtained by those ordinarily skilled in the art based on the embodiments of the present disclosure without any creative efforts fall within the protection scope of the present disclosure. It is to be understood that, the drawings are provided for reference only and are not intended to be limiting of the invention. The dimensions shown in the drawings are only for convenience of illustration and are not intended to be limiting.

It should be noted that when a component is considered to be “connected” to another component, it can be directly connected to another component or may also have a centered component. Unless otherwise defined, all technical and scientific terms used herein have the same meaning as commonly understood by those ordinarily skilled in the art. The terminology used in the specification of the present disclosure is only for the purpose of describing particular embodiments and is not intended to limit the invention.

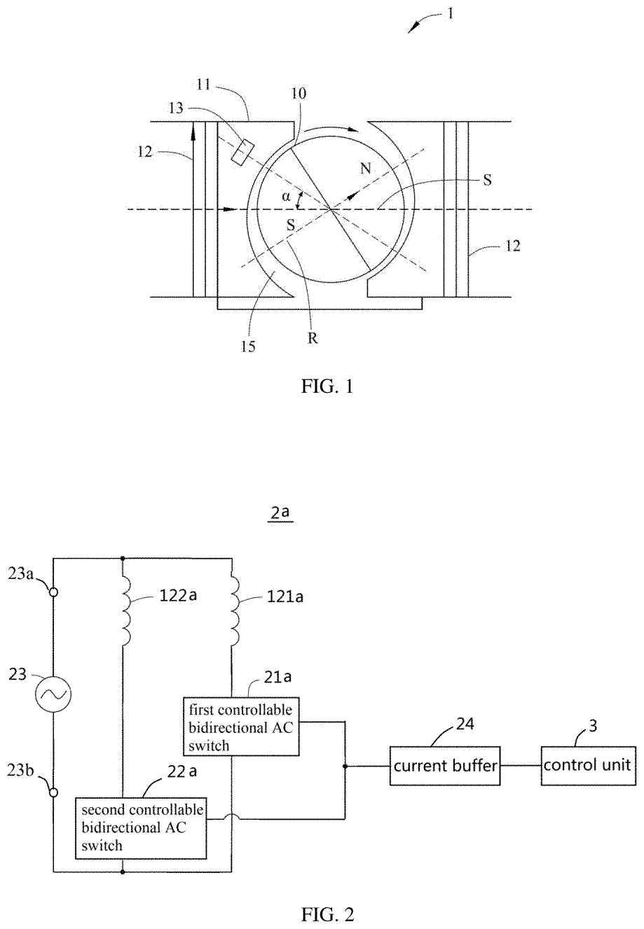

Referring to FIG. 1, FIG. 1 is a diagrammatic representation of a single phase motor according to an exemplary embodiment of the present disclosure. The single phase motor 1 includes a stator and a permanent magnet rotor 10 rotatably arranged between magnetic poles of the stator. The stator includes a stator core 11 and a stator winding 12 wound around the stator core 11. In the embodiment, the single phase motor 10 is a single phase AC motor with a permanent magnet rotor, such as a synchronous motor, which is particularly suitable for driving a load with large rotational inertia, such as a s a circulating pump.

Preferably, a non-uniform gap 15 is defined between the magnetic poles of the stator and the magnetic poles of the permanent magnet rotor 10, so that a polar axis R of the permanent magnet rotor 10 has an angular offset a relative to a polar axis S of the stator when the permanent magnet rotor 10 is at rest. The configuration ensures the permanent magnet rotor 10 have a fixed starting position every time the stator winding 12 is energized. The polar axis R of the permanent magnet rotor 10 refers to a virtual connection line passing through two centers of two symmetrical magnetic poles (two pieces of magnets in this embodiment) along a diameter of the rotor 10. The polar axis S of the stator refers to a virtual connection line passing through two centers of two symmetrical magnetic poles along a diameter of the stator. Each of the stator and the permanent magnet rotor 10 shown in FIG. 1 has two magnetic poles. The non-uniform gap 15 gradually decreases along a starting direction of the rotor. In another embodiment, pole arc surface of the stator poles is concentric with the rotor thus forming a uniform main air gap. The pole arc surface defines an inwardly-recessed startup groove, such that a non-uniform air gap is defined between the startup groove and an outer surface of the rotor 14. It can be understood that, in other embodiments, the stator and the rotor may also have more than two magnetic poles, such as 4 or 6 magnetic poles.

A position sensor 13 for detecting a magnetic field of the rotor is provided on or inside the stator at a position close to the permanent magnet rotor 10. Preferably, the position sensor 13 has an angular offset relative to a polar axis S of the stator, and the preferred offset angle in the embodiment is also a.

The single phase motor 1 further includes a motor driving circuit which drives the permanent magnet rotor 10 to rotate relative to the stator. Referring to FIG. 2, FIG. 2 is a block diagram of a single phase motor driving circuit according to a first embodiment of the present disclosure. The motor driving circuit 2a includes the stator winding 12, a control unit 3, a first controllable bidirectional AC switch 21a, a second controllable bidirectional AC switch 22a, and two power input terminals 23a, 23b for connecting to an AC power source. The AC power source 23 may preferably be a commercial AC power source with a fixed frequency of, for example, 50 Hz or 60 Hz, and the voltage may be, for example, 110 volts, 220 volts, 230 volts, and so on.

The stator winding 12 includes a first winding 121a and a second winding 122a. The first winding 121a and the first controllable bidirectional AC switch 21a are connected in series between the two power input terminals 23a, 23b. The second winding 122a and the second controllable bidirectional AC switch 22a are connected in series between the two power input terminals 23a, 23b. The control unit 3 is connected to control electrodes of the two controllable bidirectional AC switches 21a, 22a, so that the two controllable bidirectional AC switches 21a, 22a can be switched-on and switched-off at the same time. When the two controllable bidirectional AC switches 21a, 22a are switched-on, the first winding 121a and the second winding 122a are connected in parallel.

Preferably, the control electrodes of the two controllable bidirectional AC switches 21a, 22a are connected to the same terminal of the control unit 3. Preferably, the first winding 121a and the second winding 122a have the same impedance. A current buffer 24 can be connected between the control unit 3 and the two controllable bidirectional AC switches 21a, 22a, to increase a current signal output from the control unit 3.

It can be understood that the first winding 121a or the second winding 122a may be a single coil wound on one or more teeth of the stator core, or include multiple coils connected in series. Considering the above-mentioned series-connected first winding 121a and the first controllable bidirectional AC switch 21a as one branch, it can be understood that the single phase motor driving circuit 2 may include more such branches, which are connected between the two power input terminals 23a, 23b.

Referring to FIG. 3, FIG. 3 is a block diagram of a single phase motor driving circuit according to a second embodiment of the present disclosure. The single phase motor driving circuit 2b of this embodiment is substantially the same as the single phase motor driving circuit 2a of the first embodiment. The difference is that the single phase motor driving circuit 2b uses one controllable bidirectional AC switch 21b to replace the two controllable bidirectional AC switches 21a, 22a of the first embodiment. The single phase motor driving circuit 2b I includes a first winding 121b and a second winding 122b. The parallel-connected first winding 121b and second winding 122b, and the controllable bidirectional AC switch 21b are connected in series between the two power input terminals 23a, 23b. The control unit 3 is connected to a control electrode of the controllable bidirectional AC switch 21b, to control the controllable bidirectional AC switch 21b to be switched-on and switched-off.

Similarly, the first winding 121b or the second winding 122b may be a single coil wound on one or more teeth of the stator core, or include multiple coils connected in series.

It can be understood that the stator winding 12 is not limited to the first winding 121b and the second winding 122b. In other embodiments, the stator winding 12 may include more windings connected in parallel with the first winding 121b or the second winding 122b.

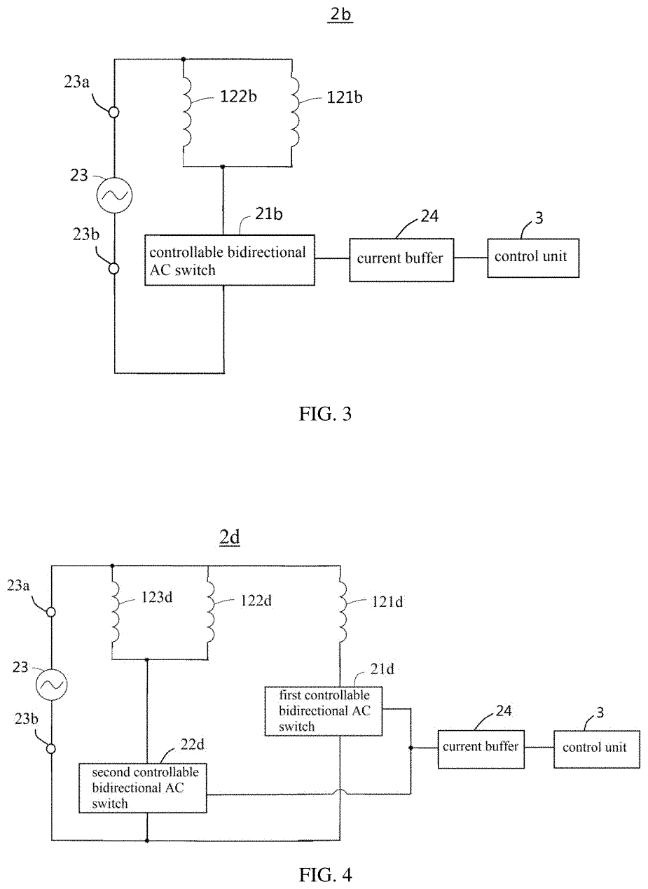

Referring to FIG. 4, FIG. 4 is a block diagram of a single phase motor driving circuit according to a third embodiment of the present disclosure. The single phase motor driving circuit 2d of this embodiment is substantially the same as the single phase motor driving circuits 2a, 2b of the first and second embodiments. The difference is that the single phase motor driving circuit 2d includes a first winding 121d, a second winding 122d and a third winding 123d. The first winding 121d and the first controllable bidirectional AC switch 21d are connected in series between the two power input terminals 23a, 23b. The parallel-connected second winding 122d and third winding 123d, and the second controllable bidirectional AC switch 22d are connected in series between the two power input terminals 23a, 23b. The control unit 3 is connected to two control electrodes of the two controllable bidirectional AC switches 21d, 22d, and controls the controllable bidirectional AC switches 21a, 22a to be switched-on and switched-off at the same time. When the two controllable bidirectional AC switches 21a, 22a are switched on, the three windings 121d, 122d, 123d are connected in parallel.

Similarly, the first winding 121d, the second winding 122d, or the third winding 123d may be a single coil wound on one or more teeth of the stator core, or include multiple coils connected in series.

It can be understood that the stator winding 12 is not limited to the first winding 121d, the second winding 122d, and the third winding 123d. In other embodiments, the stator winding 12 may include more windings connected in parallel with the second winding 122d or the third winding 123d. Considering the series-connected first winding 121d and the first controllable bidirectional AC switch 21d as one branch, the single phase motor driving circuit 2 also can include more such branches, which are connected between the two power input terminals 23a, 23b.

Compared to the existing motors, when the controllable bidirectional AC switch 21b or the first and second controllable bidirectional AC switches 21, 22a, 21d, 22d of the single phase driving circuits 2a, 2b, 2d of the present disclosure are switched on, the plurality of windings are connected in parallel. Therefore, when the total current is constant, the current flowing through each winding is reduced, so that the adverse effects caused by the stator winding 12 is reduced. Therefore, the single phase motor driving circuits 2a, 2b, 2d of the above-mentioned embodiments of the present disclosure can improve adverse effects caused by high current while ensuring a large starting torque, thereby making the single-phase motor drive circuit reliable.

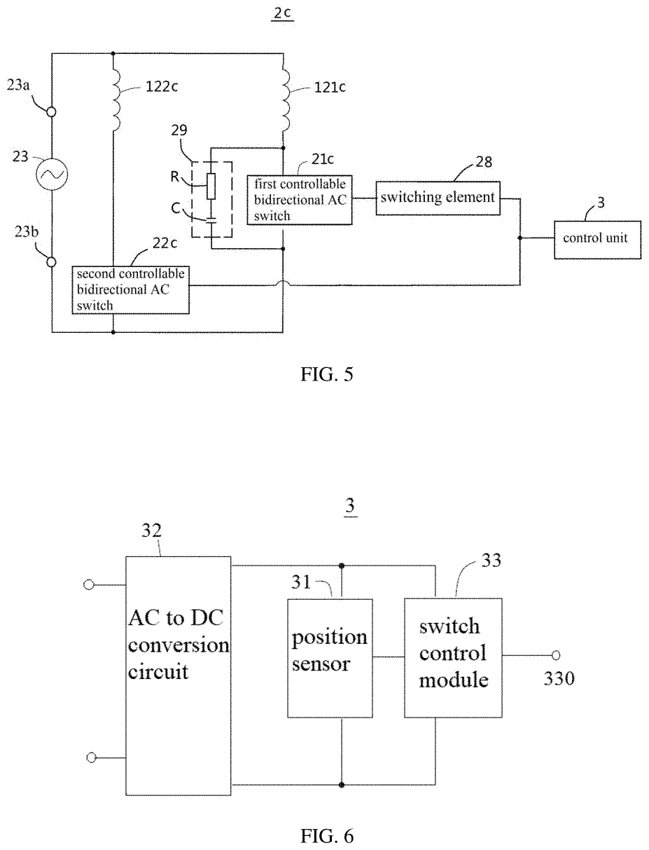

Referring to FIG. 5, FIG. 5 is a block diagram of a single phase motor driving circuit according to a fourth embodiment of the present disclosure. The motor driving circuit 2c includes a stator winding 12, a control unit 3, a first controllable bidirectional AC switch 21c, a second controllable bidirectional AC switch 22c, a switching element 28, and two power input terminals 23a, 23b for connecting to an AC power source. The stator winding 12 includes a first winding 121c and a second winding 122c. The first winding 121c and the first controllable bidirectional AC switch 21c are connected in series between the two power input terminals 23a, 23b. The second winding 122c and the second controllable bidirectional AC switch 22c are connected in series between the two power input terminals 23a, 23b. A control electrode of the first controllable bidirectional AC switch 21c is connected to the control unit 3 via the switching element 28. A control electrode of the second controllable bidirectional AC switch 22c is connected to the control unit 3. Preferably, an impedance of the first winding 121c is smaller than or equal to an impedance of the second winding 122c.

Similarly, the first winding 121c or the second winding 122c may be a single coil wound on one or more teeth of the stator core, or include multiple coils connected in series. The control unit 3 may be connected to the switching element 28 and the second controllable bidirectional AC switch 22c via a current buffer.

It can be understood that considering the series-connected first winding 121c and the first controllable bidirectional AC switch 21c, or the series-connected second winding 122c and the second controllable bidirectional AC switch 22c as one branch, the single phase motor driving circuit 2 may include more such branches, which are connected between the two power input terminals 23a, 23b.

A driving method of the single phase motor driving circuit 2c is below.

When the single phase motor is started, the switching element 28 is turned on, so the control unit 3 controls the first and second controllable bidirectional AC switch 21c, 22c to be switched-on, and the AC power source 23 and the parallel-connected first and second windings 121c, 122c forms a loop circuit.

When the single phase motor is successfully started, the switching element 28 is turned off, so the connection between the control electrode of the first controllable bidirectional AC switch 21c and the control unit 2 is cut off, so the first controllable bidirectional AC switch 21c is switched off, and the AC power source 23 and the second winding 122c forms a loop circuit.

When the motor is started, the first winding 121c and the second winding 122c are connected in parallel to increase output torque, so a total current flowing through the stator winding 12 is large. After the motor is started successfully, only the second winding 122c is included in the motor driving circuit, so an impedance of the motor increases, and thus reducing the current flowing through the stator winding 12.

Preferably, a surge voltage suppression unit 29 is connected to two main electrodes of the first controllable bidirectional AC switch 21c. The surge voltage suppression unit 29 is configured to prevent an induced electromotive force generated by the first winding 121c from being suddenly applied to the first controllable bidirectional AC switch 21c and causing damage to it, at the moment when the first controllable bidirectional AC switch 21c is switched off. In the embodiment, the surge voltage suppression unit 29 may be an RC series circuit. That is, the first main electrode of the first controllable bidirectional AC switch 21c is connected to its second main electrode via a resistor R and a capacitor C.

Referring to FIG. 6, FIG. 6 is a block diagram of a control unit of the single phase driving circuits illustrated in FIGS. 2 to 5. The control unit 3 includes an AC to direct current (DC) conversion circuit 32, a position sensor 31 and a switch control module 33. An input terminal of the AC to DC conversion circuit 32 receives an AC power. The AC to DC conversion circuit 32 converts the AC power into a low-voltage DC power, and provides the DC power to the position sensor 31 and the switch control module. The position sensor 31 is configured to detect a magnetic field of the permanent magnet rotor 10 of the motor, and output a corresponding signal representing the magnetic field of the permanent magnet rotor 10. The switch control module 33 is connected to the AC to DC conversion circuit 32 and the position sensor 31. The switch control module 33 further includes an input/output terminal 330, which is directly or indirectly connected to the above controllable bidirectional AC switch 21a, 22a, 21b, 21c, 22c, 21d, 22d. The switch control module 33 is configured to control the controllable bidirectional AC switch to be switched between a switch-on state and a switch-off state in a predetermined way, based on the magnetic field of the rotor and a voltage polarity of the AC power source 23, so that the permanent magnet rotor rotates along a predetermined direction.

Preferably, the switch control module 33 is configured to switch on the controllable bidirectional AC switch, when the AC power source 23 is in a positive half cycle and the position sensor 31 detects that the magnetic field of the rotor is a first polarity, and when the AC power source 23 is in a negative half cycle and the position sensor 31 detects that the magnetic field of the rotor is a second polarity which is opposite to the first polarity. The first polarity is N-pole or S-pole; correspondingly, the second polarity is S-pole or N-pole.

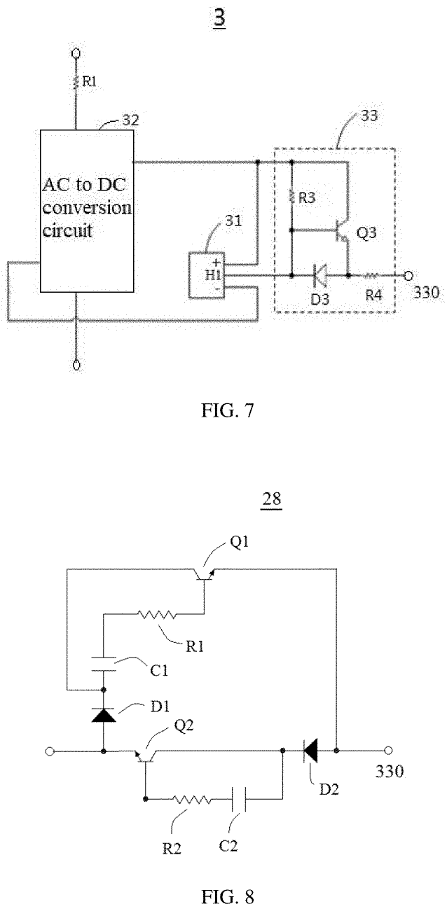

Referring to FIG. 7, FIG. 7 is a circuit diagram of the control unit of FIG. 6 according to a preferable embodiment of the present disclosure. A first input terminal of the AC to DC conversion circuit 32 is connected to one end of the AC power source 23 via a dropping resistor R1; and a second input terminal of the AC to DC conversion circuit 32 is connected to another end of the AC power source 23. In the other embodiment, the first input terminal of the AC to DC conversion circuit 32 is connected to one end of the AC power source 23 via the dropping resistor R1 and the stator winding 12. The position sensor 31 includes two power terminals and an output terminal H1. The two power terminals of the position sensor 31 are respectively connected to two output terminals of the AC-DC conversion circuit 32. The output terminal H1 is configured to output a signal representing the magnetic field of the permanent rotor 10.

The switch control module 30 includes a resistor R3, an NPN transistor Q3, and a resistor R4 and a diode D3 connected in series between the output terminal H1 of the position sensor 20 and the input/output terminal 330. A cathode of the diode D3 is connected to the output terminal H1 of the position sensor 31. One end of the resistor R3 is connected to a relatively high voltage output terminal of the AC to DC conversion circuit 32, and another end of the resistor R3 is connected to the output terminal H1 of the position sensor 31. A base of the NPN transistor Q3 is connected to the output terminal H1 of the position sensor 31, an emitter of the NPN transistor Q3 is connected to an anode of the diode D3, and a collector of the NPN transistor Q3 is connected to the relatively high voltage output terminal of the AC to DC conversion circuit 32.

It can be understood that the FIG. 7 is only an exemplary illustration of the circuit of the switch control module 33, and the circuit of the switch control module of the present disclosure is not limited to that described in this embodiment. As long as the circuit can achieve the same or similar functions, it can be used as the switch control module of the present disclosure.

Referring to FIG. 8, FIG. 8 is a circuit diagram of a switching element of the single phase motor driving circuit illustrated in FIG. 5 according to a preferable embodiment of the present disclosure. The switching element 28 includes a first switching transistor Q1, a second switching transistor Q2, a first resistor R1, a second resistor R2, a first capacitor C1, a second capacitor C2, a first diode D1 and a second diode D2.

A control terminal of the first switch transistor Q1 is connected to a control electrode of the first controllable bidirectional AC switch 21c via the first resistor R1, the first capacitor C1, a cathode and an anode of the first diode D1 in turn. A first terminal of the first switching transistor Q1 is connected to the input/output 330 of the control unit 3, and a second terminal of the first switching transistor Q1 is connected to the cathode of the first diode D1.

A control terminal of the second switch transistor Q2 is connected to the input/output terminal 330 of the control unit 3 via the second resistor R2, the second capacitor C2, a cathode and an anode of the second diode D2 in turn. A first terminal of the second switching transistor Q2 is connected to the control electrode of the first controllable bidirectional AC switch 21c, and a second terminal of the second switching transistor Q2 is connected to the cathode of the second diode D2.

In this embodiment, the first switching transistor Q1 and the second switching transistor Q2 are NPN transistors. The first terminals of the two switching transistors Q1, Q2 are emitters of the transistor, the second terminals of the two switching transistors Q1, Q2 are collectors of the transistor, and the control terminals of the two switching transistors Q1, Q2 are bases of the transistor. In other embodiments, the two switching transistors Q1, Q2 can also be field effect transistor or the like.

When the motor is started, if the AC power source 23 is in a positive half cycle and the magnetic field of the permanent magnet rotor is the first polarity, the input/output terminal 330 of the control unit 3 outputs current to the second diode D2, and the current flowing through the second diode D2 charges the second capacitor C2. At the same time, the current flows through the second capacitor C2 and the second resistor R2 to reach the base of the second switching transistor Q2, turning on the second switching transistor Q2, so that the current output by the control unit 3 flows into the control electrode of the first controllable bidirectional AC switches 21c via the second switching transistor Q2, triggering the first controllable bidirectional AC switch 21c to be switched on. Then, the current flowing through the second diode D2 continues to charge the second capacitor C2. When the second capacitor C2 is fully charged, the second capacitor C2 is equivalent to an open circuit, and the current cannot flow through the second capacitor C2 to reach the base of the second switching transistor Q2, so the second switching transistor Q2 is turned off, and the connection between the control unit 3 and the control electrode of the first controllable bidirectional AC switch 21c is cut off. Therefore, the first controllable bidirectional AC switch 21c is switched off after the motor is started.

When the motor is started, if the AC power source 23 is in a negative half cycle and the magnetic field of the permanent magnet rotor is the second polarity, the current output by the AC power source 23 charges the first capacitor C1 via the second main electrode and the control electrode of the first controllable bidirectional AC switch 21c and the first diode D1 in turn. At the same time, the current flows through the first capacitor C1 and the first resistor R1 to the base of the first switching transistor Q1, turning on the first switching transistor Q1, so that the current flows into the control unit 3 from the control electrode of the first controllable bidirectional AC switch 21c, triggering the first controllable bidirectional AC switches 21c to be switched on. Then, the current flowing through the first diode D1 continues to charge the first capacitor C1. When the first capacitor C1 is fully charged, the first capacitor C1 is equivalent to an open circuit, and the current can no longer pass through the first capacitor C1 to reach the base of the first switching transistor Q1, so the first switching transistor Q1 is turned off, and the current can no longer flow into the control unit 3. Therefore, the first controllable bidirectional AC switch 21c is switched off after the motor is started.

It can be understood that the switching element 28 is not limited to those described in the above embodiments, and any circuits or modules with the same function are acceptable. For example, the switching element 28 may include a switch connected between the first controllable bidirectional AC switch 21c and the control unit 3, and a timer, etc. for controlling the switch to be turned on or turned off.

The single phase driving circuit 2c of the fourth embodiment of the present disclosure has a relatively high current when the motor is started, and the current flowing through the stator winding 12 is reduced after the motor is started. Therefore, the single phase driving circuit 2c of the fourth embodiment also can improve adverse effects caused by high current while ensuring sufficient starting torque, so that the single phase motor driving circuit has a good reliability.

The controllable bidirectional AC switch 21b, the first controllable bidirectional AC switch 21a, 21c, 21d, and the second controllable bidirectional AC switch 22a, 22c, 22d of the present disclosure are preferably triacs. It can be understood that these controllable bidirectional AC switches also can be realized by, for example, two silicon-controlled rectifiers connected inversely in parallel, and corresponding control circuits are provided to control the two silicon-controlled rectifiers in a predetermined manner.

Although certain inventive embodiments of the present disclosure have been specifically described, the present disclosure is not to be construed as being limited thereto. Various changes or modifications may be made to the present disclosure without departing from the scope and spirit of the present disclosure.

1. A single phase motor driving circuit for driving a permanent magnet rotor of the motor to rotate relative to a stator, the single phase motor driving circuit comprising a stator winding, a control unit, a controllable bidirectional AC switch, and two power input terminals configured to connect an AC power source,
wherein the stator winding comprises a first winding and a second winding;
the parallel-connected first winding and second winding, and the controllable bidirectional AC switch are connected in series between the two power input terminals; and
the control unit is connected to a control electrode of the controllable bidirectional AC switch, to control the controllable bidirectional AC switch to be switched on and off.

2. The single phase motor driving circuit of claim 1, wherein a current buffer is connected between the control unit and the control electrode of the controllable bidirectional AC switch.

3. The single phase motor driving circuit of claim 1, wherein the stator winding further comprises at least one winding connected in parallel with the first winding or the second winding.

4. The single phase motor driving circuit of claim 1, wherein the control unit comprises a position sensor and a switch control module, the position sensor is configured to detect a magnetic field of the permanent magnet rotor, and output a corresponding signal representing the magnetic field; and
the switch control module is configured to switch on the controllable bidirectional AC switch, when the AC power source is a positive half cycle and the magnetic field detected by the position sensor is the first polarity, and when the AC power source is a negative half cycle and the magnetic field detected by the position sensor is the second polarity opposite to the first polarity.

5. A single phase motor driving circuit for driving a permanent magnet rotor of the motor to rotate relative to a stator, the single phase motor driving circuit comprising a stator winding, a control unit, a first controllable bidirectional AC switch, a second controllable bidirectional AC switch, and two power input terminals configured to connect an AC power source,
wherein the stator winding comprises a first winding and a second winding;
the first winding and the first controllable bidirectional AC switch are connected in series between the two power input terminals;
the second winding and the second controllable bidirectional AC switch are connected in series between the two power input terminals; and
the control unit is connected to control electrodes of the first controllable bidirectional AC switch and the second controllable bidirectional AC switch, to control the two controllable bidirectional AC switches to be switched on and off at the same time.

6. The single phase motor driving circuit of claim 5, wherein the stator winding further comprises at least one winding which is connected in parallel with the second winding.

7. The single phase motor driving circuit of claim 5, further comprising at least one branch connected between the two power input terminals, wherein the branch comprises a winding and a controllable bidirectional AC switch which are connected in series.

8. The single phase motor driving circuit of claim 5, wherein a current buffer is connected between the control unit and the control electrode of the first controllable bidirectional AC switch, and is also connected between the control unit and the control electrode of the second controllable bidirectional AC switch.

9. The single phase motor driving circuit of claim 5, wherein the control unit comprises a position sensor and a switch control module, the position sensor is configured to detect a magnetic field of the permanent magnet rotor, and output a corresponding signal representing the magnetic field; and
the switch control module is configured to switch on the two controllable bidirectional AC switches, when the AC power source is a positive half cycle and the magnetic field detected by the position sensor is the first polarity, and when the AC power source is a negative half cycle and the magnetic field detected by the position sensor is the second polarity opposite to the first polarity.

10. A single phase motor driving circuit for driving a permanent magnet rotor of the motor to rotate relative to a stator, the single phase motor driving circuit comprising a stator winding, a control unit, a first controllable bidirectional AC switch, a second controllable bidirectional AC switch, and two power input terminals configured to connect an AC power source,
wherein the stator winding comprises a first winding and a second winding;
the first winding and the first controllable bidirectional AC switch are connected in series between the two power input terminals;
the second winding and the second controllable bidirectional AC switch are connected in series between the two power input terminals;
the control unit is connected to a control electrode of the first controllable bidirectional AC switch via a switching element, the control unit is connected to a control electrode of the second controllable bidirectional AC switch; and
the switching element is turned on when the motor is started, and the switching element is turned off after the motor is successfully started.

11. The single phase motor driving circuit of claim 10, wherein a surge voltage suppression unit is connected between two main electrodes of the first controllable bidirectional AC switch.

12. The single phase motor driving circuit of claim 10, wherein the switching element comprises a switch connected between the control electrode of the first controllable bidirectional AC switch and the control unit, and a timer for controlling the switch to be turned on or off.

13. The single phase motor driving circuit of claim 10, wherein the switching element comprise a first switching transistor, a second switching transistor, a first resistor, a second resistor, a first capacitor, a second capacitor, a first diode and a second diode;
a control terminal of the first switch transistor is connected to a control electrode of the first controllable bidirectional AC switch via the first resistor, the first capacitor, a cathode and an anode of the first diode in turn, a first terminal of the first switching transistor is connected to the control unit, and a second terminal of the first switching transistor is connected to the cathode of the first diode; and
a control terminal of the second switch transistor is connected to the control unit via the second resistor, the second capacitor, a cathode and an anode of the second diode in turn, a first terminal of the second switching transistor is connected to the control electrode of the first controllable bidirectional AC switch, and a second terminal of the second switching transistor is connected to the cathode of the second diode.

14. The single phase motor driving circuit of claim 10, wherein the control unit comprises a position sensor and a switch control module, the position sensor is configured to detect a magnetic field of the permanent magnet rotor, and output a corresponding signal representing the magnetic field; and
the switch control module is configured to switch on the corresponding controllable bidirectional AC switch only when the AC power source is a positive half cycle and the magnetic field detected by the position sensor is the first polarity, and the AC power source is a negative half cycle and the magnetic field detected by the position sensor is the second polarity opposite to the first polarity.
